(19) United States
(12) Patent Application Publication
(10) Pub. No.: US 2020/0386669 A1
(43) Pub. Date: Dec. 10, 2020

(54) High-Flow Absorbance Cell

(71) Applicant: Ilkka Lahdesmaki, Seattle, WA (US)

(72) Inventors: Ilkka Lahdesmaki, Seattle, WA (US); Adam Bigelow, Seattle, WA (US)

(73) Assignee: FIAlab Instruments, Inc., Seattle, WA (US)

(21) Appl. No.: 16/432,268

(22) Filed: Jun. 5, 2019

(51) Int. Cl. G01N 21/05; G01N 21/03

(52) U.S. Cl. CPC G01N 21/05; G01N 2021/0346; G01N 21/0303

(57) ABSTRACT

An optical flow cell cuvette with short optical and fluidic paths, perpendicular to one another, with neither constriction nor any obstruction to fluid flow in the fluidic channel. Optical windows mounted flush to the walls of the rectangular fluidic channel keeps the light path short while keeping through-put high and maintaining a uniform cross-sectional area along the whole channel. Optical windows are independent of body structure allowing flexibility in manufacture and application.

### CROSS-REFERENCE TO RELATED APPLICATIONS

This application is a continuation of U.S. patent application No. 62/637,647, filed Mar. 2, 2018

### STATEMENT REGARDING FEDERALLY SPONSORED RESEARCH OR DEVELOPMENT

Not Applicable

### THE NAMES OF THE PARTIES TO A JOINT RESEARCH AGREEMENT

Ilkka Johannes Landesmaki

Adam Bigelow

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### BACKGROUND OF THE INVENTION

### (1) Field of the Invention

The present invention relates to optical transmission measurements of a liquid or gas stream. The invention could be classified as a flow-through cuvette (CPC G01N21/05)

### (2) Description of Related Art Including Information Disclosed Under 37 CFR 1.97 and 1.98

Optical transmission measurements are useful for quantification of chemical and physical entities that exhibit optical absorptivity or turbidity (scattering). For measurements on bench top spectrometers, the sample under inspection is contained in a cuvette that is placed in the optical path of the spectrometer. For measurements of fluid streams, such as flow-based analytical instrumentation (HPLC, FIA, SFA), or in-line measurements of industrial process streams, a flow-through type cell is required in place of a container type cuvette. The flow cell must provide a liquid inlet and outlet, as well as an optical input and output. Such flow cells have been long available for traditional bench top spectrometers from several suppliers. A design is described in UK Pat. 1469189A.

The development of miniature fiber optic spectrometers has made it possible to locate the spectrometer away from the sample, which is an advantage especially for process measurements. The use of a fiber optic spectrometer requires a specific type of flow cell, capable of connecting to fiber optic cables to route light from a light source to the optical input port, and from the optical output port to the spectrometer. Such flow cells are also presently commercially available from several suppliers.

Most commercial fiber optic flow cells rely on a Z-shaped flow path where the fluidic and optical paths are parallel in the part of the flow cell where detection takes place, while outside of the detection region the fluidic path is oriented in a different direction. Since the Z-type design must allow space for channel turns inside the flow cell, it does not lend itself well to short optical paths. A short-path cell can be achieved with the Z-design, but only by reducing the channel diameter. U.S. Pat. No. 6,542,231 is an example of a cell design with a narrow-bore channel, made for the purpose of HPLC detection.

For many measurements, an important example being process monitoring, narrow-bore flow cells are not a viable alternative, as the application may require accommodation of high flow rates. A narrow-bore cell generates high back-pressure in high-flow conditions, which in most cases is undesirable. Implementation of a short optical path cell for such measurements therefore has to abandon the Z-design. A short-path flow cell that can satisfy the high flow rate demand is described in U.S. Pat. No. 5,408,313. The design features movable inserts to define the optical path length. A similar principle with movable fiber optic cables has been outlined in academic publications (e.g. Ruzicka J, Analyst, 2000, 125, 1053-1060). In both of the above cases, short-path detection in high-flow conditions is achieved by making the flow path perpendicular to the optical path. Both of the above approaches employ optical inserts protruding into the flow channel, the gap between the inserts defining the optical path. The protrusions can make the flow cell prone to catching bubbles or debris.

In addition, both approaches mentioned above rely on the use of flow channels with a circular cross-section. A circular channel geometry prevents complete alignment of the windows (which are flat) with the channel walls (which are curved). Therefore, smooth internal surfaces cannot be achieved even if the gap between the inserts was adjusted to be equal to the channel diameter.

A flow cell with a rectangular cross section and smooth, continuous walls is described in U.S. Pat. No. 5,371,585. This flow cell, however, is not intended for use with fiber optic spectrometers and therefore the design does not include a possibility for fiber optic connectors. Instead, traditional optical systems of lenses and mirrors are used for light delivery and collection. Furthermore, the entire flow cell body is made out of the optical material (sapphire), while in the present invention the body and window materials can be chosen independent of one another. This makes it possible to design the present invention around standard circular windows, as opposed to custom shaped window parts. It also makes it possible to fabricate the body out of a material that is easy to machine, facilitating the production process.

The present invention outlines a flow cell that avoids protruding elements in the flow path, yet provides a way to carry out short-path detection without constricted fluid channels. The flow cell can accommodate connectors for fiber optic cables, making it amenable for use with fiber optic spectrometers.

### BRIEF SUMMARY OF THE INVENTION

The claimed invention is a novel flow-through cuvette design that overcomes problems previously known in the art. The flow cell is designed in such a way that the fluidic and optical paths are short and that where the fluidic and optical channels cross, the windows used are mounted to be flush with the walls of the fluidic channel. The resultant channel is rectangular in cross section and uniform in cross sectional area; the channel geometry allows uniform through-put and leaves next to no “un-swept” volume. This contrasts with previous designs where fluidic channels have either, varied in cross sectional area, and/or have had protrusions into the channel at the point where measurements are taken.

The present invention allows the use of standard optical windows meaning that the body does not need to be made of the required optical material; this is advantageous in that it facilitates flexibility in both manufacture and optical application.

### BRIEF DESCRIPTION OF THE SEVERAL VIEWS OF THE DRAWING(S)

FIG. 1 is a schematic representation of a cross-sectional view of the flow cell as if it were cut along its longest axis (side view). The fluidic path runs vertically while the light path runs horizontally.

FIG. 2 is a schematic representation of the flow cell (end view). The light path runs vertically while the fluidic path runs perpendicular to the plane of view.

FIG. 3 is a schematic representation of the flow cells (side view). The fluidic path runs vertically while the light path runs perpendicular to the plane of view.

### DETAILED DESCRIPTION OF THE INVENTION

The present invention enables optical transmission measurements of moving fluids, across a short optical path, with no protruding elements in the detection area.

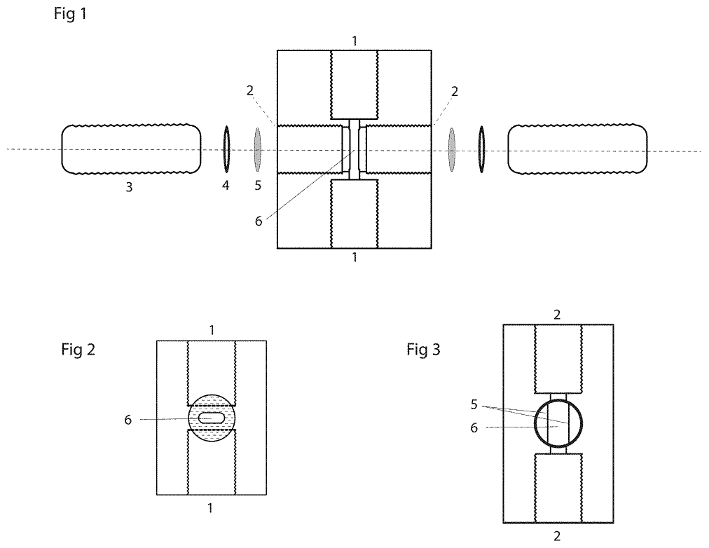

A side view of the flow cell is shown in FIG. 1. Fluidic ports 1 provide attachment for fluidic connectors and tubing. Optical ports 2 provide attachment for adapters 3 which hold in place seals 4 and windows 5. The inner window surface is flush with the wall of the flow channel 6. The threaded adapters 3 also provide attachment for fiber optic cables.

An end view of the flow cell is shown in FIG. 2. The cross section of the flow channel 6 has a rectangular shape, which maximizes cross-sectional area while allowing the optical path to be kept short. Furthermore, the rectangular shape provides a way of making the inner window surface flush and aligned with the channel wall.

A side view of the flow cell is shown in FIG. 3. The edges 5 of the fluidic channel 6 provide physical support that the windows rest on.

The previously unknown feature of the present invention is providing a design where the optical windows are flush and aligned with the walls of the flow channel. The advantage of such a design is that it minimizes entrapment of bubbles and debris around the detection area, and thus maximizes robustness and signal quality provided by the flow cell.

While certain specific details and embodiments have been described to illustrate the principles of the present invention, it will be apparent to those skilled in the art that many modifications are possible within the scope of the disclosed invention.

### SEQUENCE LISTING

Not Applicable

What is claimed is:

1. A flow cell for optical transmission measurements with said flow cell comprising:
a body structure that includes short-path optical and fluid channels, running perpendicular to one another, with each channel terminating in threaded apertures for optical and fluid ports respectively.
where the optical and fluid channels cross, separation of the two is achieved using two windows, one mounted on the bottom of each optical port, in such a manner that the surface of the window facing the sample stream is at the same level and orientation as the inner wall of the flow channel.
threaded adapters, used in conjunction with seals to keep the windows in place at the bottom of each optical port. These adapters also provide attachment for fiber optic cables.
a fluid path that is rectangular in cross-section and uniform in cross-sectional area from proximal to distal fluidic ports; there are no protrusions nor partial obstructions within the fluid channel.
